(19) United States
(12) Patent Application Publication
(10) Pub. No.: US 2026/0258766 A1
(43) Pub. Date: Sep. 3, 2026

(54) A PISTON AND AN INTERNAL COMBUSTION ENGINE SYSTEM

(71) Applicant: VOLVO TRUCK CORPORATION, Göteborg (SE)

(72) Inventors: Martin SVENSSON, Kungsbacka (SE); Jonathan HAFSTRÖM, Mölndal (SE); Josefin LEIBRATT, Göteborg (SE); Gustaf GELL MALONE, BORGVIK (SE)

(73) Assignee: VOLVO TRUCK CORPORATION, Göteborg (SE)

(21) Appl. No.: 18/877,705

(22) PCT Filed: Jul. 4, 2022
(86) PCT No.: PCT/EP2022/068448

§ 371 Date: Dec. 20, 2024

(51) Int. Cl. F02F 3/26

(52) U.S. Cl. CPC F02F 3/26

(57) ABSTRACT

The disclosure relates to a piston for an internal combustion engine, ICE, said piston extending in an axial direction and a radial direction, and having an axial top end comprising a piston bowl intended to form part of a combustion chamber, said piston bowl having an axial floor portion with a floor surface, a circumferential rim portion extending in the axial direction between the floor surface and a top end surface of the axial top end, said piston bowl further having an axial depth defined by an axial distance between said floor surface and said top end surface, said piston bowl further comprising a plurality of spaced-apart protrusions circumferentially distributed around said circumferential rim portion, each one of the spaced-apart protrusions having opposite radial side sections, and further a flat surface or concave surface extending between said opposite radial side sections. The present disclosure also relates to an internal combustion engine system.

### TECHNICAL FIELD

The present disclosure relates to a piston for an internal combustion engine. The present disclosure further relates to an internal combustion engine system for a vehicle, wherein the internal combustion engine comprises a piston. The disclosure is applicable on vehicles, in particularly heavy-duty vehicles, such as e.g. trucks. However, although the present disclosure will mainly be described in relation to a truck, the internal combustion engine system may also be applicable for other types of vehicles propelled by means of an internal combustion engine. In particular, the present disclosure can be applied in heavy-duty vehicles, such as trucks, buses and construction equipment, but also in cars and other light-weight vehicles etc. Further, the internal combustion engine is typically a diesel internal combustion engine, however other fuels may also be possible to use in combination with the piston, such as hydrogen and natural gas. The present disclosure may also be applied in other machines such as power generators and construction equipment. The present disclosure may further be applied in marine vessels or the like.

### BACKGROUND

In the field of internal combustion engine arrangements, numerous efforts are made to accomplish efficient combustion which is also satisfactory in view of residual products, in particular soot particle and NOx emissions, although also carbon monoxide emissions, and hydrocarbon emissions from diesel fuel may naturally be considered.

A combustion process in which e.g. diesel fuel is injected directly into the cylinder and is ignited by increased temperature and pressure in the cylinder is generally referred to as a compression ignition combustion process. Another type of ignition process for some gaseous fuels is the spark-ignition combustion process. When the fuel is ignited in the cylinder, combustion gases present in the cylinder undergo turbulent mixing with the burning fuel, so that a mixture-controlled diffusion flame is formed. The combustion of the fuel/gas mixture in the cylinder gives rise to heat generation which causes the gas in the cylinder to expand. The expansion of the gas then causes the piston to move in the cylinder. Depending on a number of parameters, such as the fuel type, the injection pressure of the fuel, the quantity of exhaust gases recirculated to the cylinder, the time of injection of the fuel and the turbulence prevailing in the cylinder, different engine efficiency and emission values are obtained.

To control and in particular to reduce emissions from the combustion process in a combustion engine, it has been proposed to utilise the shape of the piston bowl surface facing towards the combustion chamber. The piston bowl surface is part of a piston crown of the reciprocating piston in a cylinder. To this end, the piston bowl surface may be designed so as to affect various parameters inside the combustion chamber such as flame propagation, mixing energy, kinetic energy distribution, and/or swirl.

It has also been observed that the shape of the piston bowl may affect combustion and/or mixing of fuels within the cylinder in other types of internal combustion engines, such as gaseous fuel engines, e.g. hydrogen internal combustion engines.

WO 2017/108103 A1 discloses one example of a piston crown for a piston, wherein the piston crown comprises a piston bowl surface having a plurality of circumferentially spaced protrusions in a circumferential rim portion.

Despite the activity in the field, there is a desire for further improving such types of pistons for an internal combustion engine (ICE) system for a heavy-duty vehicle.

### SUMMARY

An object of the disclosure is to provide an enhanced piston design for a reciprocating piston intended for operating in an internal combustion engine system. The object is at least partly achieved by a piston according to claim 1. The object is at least partly also achieved by a piston according to claim 18. The object is also at least partly achieved by the other independent claims. The dependent claims relate to advantageous embodiments.

According to a first aspect of the disclosure, there is provided a piston for an internal combustion engine, ICE. The piston extends in an axial direction and a radial direction. The piston has an axial top end comprising a piston bowl intended to form part of a combustion chamber. The piston bowl has an axial floor portion with a floor surface, a circumferential rim portion extending in the axial direction between the floor surface and a top end surface of the axial top end. The piston bowl further has an axial depth defined by an axial distance between the floor surface and the top end surface. Moreover, the piston bowl comprises a plurality of spaced-apart protrusions circumferentially distributed around the circumferential rim portion. Each one of the spaced-apart protrusions extends a substantial part in the radial direction towards a centre axis, and further extending a substantial part in the axial direction from the floor surface towards the top end surface, each one of the spaced-apart protrusions having opposite radial side sections. Further, each one of the spaced-apart protrusions comprises a flat surface or a concave surface extending between the opposite radial side sections. The flat surface or concave surface has a first circumferential extension at an intersection between the flat surface or concave surface and the floor surface, and further a second circumferential extension at an axial distance from the floor surface, the axial distance being a quarter of the axial depth of the piston bowl. In addition, a ratio between the second circumferential extension and the first circumferential extension is 0.4 or less.

Accordingly, the first circumferential extension is larger than the second circumferential extension.

Hereby, the proposed piston provides for an improved design of the protrusions at a lower area of the piston bowl, which then generally intersects with the dome part of the piston bowl.

The present disclosure is at least partly based on the insight that there is a challenge to simultaneously achieve reductions in fuel consumption and emissions without sacrificing the durability of the piston. By way of example, some dimensions of the protrusions are favourable for a decent combustion performance whilst other dimensions may directly have an impact on the durability of the piston. That is, when using protrusions on a piston bowl for a piston intended for a diesel ICE system, there is generally also an introduction of stress concentrations on or within the piston. In this context, it has been observed that the lower area of the protrusions, i.e. the area near the floor portion of the piston bowl, is one region among many regions where the impact on combustion performance is relatively low but the impact on the durability is relatively high.

The proposed piston thus aims at improving the protrusions of a piston bowl of a piston so as to provide a sufficiently reliable durability in terms of fatigue life, and without compromising any functions of the protrusions relating to combustion of the fuel within the combustion chamber of the cylinder.

By the provision of having protrusions, the design of the piston contributes to an enhanced combustion process for fuels such as diesel fuel and/or an enhanced mixing of air and fuel for other types of fuels, such as a hydrogen gas fuel. The protrusions may further provide for a sudden change in the side-profile of the protrusion so as to achieve a well-defined flow release location.

Moreover, by having protrusions comprising the flat surface or concave surface extending between opposite radial side sections in combination with the provision that the ratio between the second circumferential extension and the first circumferential extension is 0.4, or less, the proposed piston provides a less sensitive design of the protrusions in terms of required fatigue life and required durability. As such, the piston may better withstand critical fatigue conditions that occur during ordinary use of the piston in heavy-duty vehicles.

More specifically, by the above configuration of the protrusions, the part of the protrusion where there is a low impact on combustion performance is designed so as to minimize the compressive stress at the protrusions in the lower region towards the dome (centre of piston) for the temperature load, i.e. compressive stress in the radial direction, whilst also separating the location of the maximum compressive stress due to temperature load from the maximum tensile stress location due to the pressure load. A piston bowl with protrusions where maximum stress regions are separated from each other contributes to increasing the fatigue life of the protrusions and the piston.

The proposed protrusions are generally provided to enhance fuel flames interaction with the surfaces forming the piston bowl and with adjacent flames. However, whilst the proposed piston can be incorporated in a number of different types of ICE systems, the proposed piston may be particularly suitable for ICE systems fuelled by a high-pressure injection of a fuel containing liquid diesel or a pressure injection of a gaseous fuel such as a hydrogen fuel, where the fuel injection duration occurs near the top dead centre (TDC). In hydrogen ICE system, the proposed piston design having the above protrusion segment may improve the mixing of hydrogen gas and compressed air prior to an ignition event.

The protrusions can be provided in several different geometries, shapes and disposed at various location along the side section. By way of example a ratio between the sum of the first circumferential extensions of all spaced-apart protrusions along the circumferential rim portion and a circumferential extension of the circumferential rim portion may be at least 30%, preferably at least 45%, and most preferred at least 60%. Such arrangement of the protrusions relative to the circumferential extension will further improve the properties of the piston design in terms of required durability etc.

A first radial side section of the opposite radial side sections may intersect with the flat surface or concave surface along an intersection edge. Analogously, a second radial side section of the opposite radial side sections may intersect with the flat surface or concave surface along another opposite intersection edge.

The intersection edges in combination with the first circumferential extension and the second circumferential extension may define the extension of the flat surface or the concave surface.

Each one of the intersection edges may incline from the first circumferential extension to the second circumferential extension in a linear manner or in a non-linear manner, such as in a curved manner. Typically, the intersection edges may incline towards a centre region located on the second circumferential extension. By way of example, the intersection edges may incline from the first circumferential extension to the second circumferential extension in a curved manner, as seen in the circumferential direction and in the radial direction.

The intersection edges in combination with the first circumferential extension and the second circumferential extension may define a surface resembling a trapezoid or a triangular shape. Such shapes may further improve the properties of the protrusions in terms of required durability.

A concave surface substantially extending in the circumferential direction contributes to an improved configuration of the protrusion. The concave surface of the protrusion may generally be the surface of the protrusion that is arranged to face the axial centre of the piston bowl. Typically, although strictly not required, a radius of curvature of the concave surface may always be essentially perpendicular to the axial centre of the piston bowl.

An extension of the flat surface or the concave surface from the first circumferential extension to the second circumferential extension may further comprise a concave axially extending region.

One advantage with a concave surface in the axial direction is that the portion of protrusion intersecting with the floor surface provides for a smooth transition between the protrusion and the floor portion.

An extension of the flat surface from the first circumferential extension to the second circumferential extension may be defined by a flat surface profile. That is, in the axial direction, the flat surface from the first circumferential extension to the second circumferential extension may be defined by a flat surface profile.

The radial side sections may typically be curved convex side sections, respectively.

Each one of the opposite radial side sections may comprise multiple regions of different convex curved profiles.

The radial side sections may generally extend in the radial direction. Hence, the radial side sections are radially extending side sections. The radial side section may typically extend from the circumferential rim portion. The radial side section may typically extend from the circumferential rim portion and towards the centre axis.

The radial side section may typically also extend substantially in the axial direction. The spaced-apart protrusions may be uniformly circumferentially distributed along the circumferential rim portion.

The spaced-apart protrusions may be non-uniformly circumferentially distributed along the circumferential rim portion.

Each one of the spaced-apart protrusions may extend in the axial direction from the floor surface to the top end surface of the piston top end. In another example, each one of the spaced-apart protrusions may extend in the axial direction from the floor surface to the second circumferential extension. As mentioned above, the second circumferential extension is axially located at the axial distance from the floor surface. The axial distance is a quarter of the depth of the piston bowl. In other examples, each one of the spaced-apart protrusions may extend in the axial direction from the floor surface to a given intermediate axial distance being greater than the quarter of the depth of the piston bowl but less than the depth of the piston bowl. In other words, each one of the spaced-apart protrusions may extend in the axial direction from the floor surface towards to a distance in the axial direction between the quarter of the depth of the piston bowl but less than the depth of the piston bowl.

In addition, or alternatively, the flat surface or concave surface may extend in the axial direction from the intersection between the flat surface or concave surface and the floor surface and towards the top end surface of the piston top end.

In some examples, the flat surface or concave surface may extend in the axial direction from the intersection between the flat surface or concave surface and the floor surface to the top end surface of the piston top end. In another example, the flat surface or concave surface may extend in the axial direction from the floor surface to the second circumferential extension. By way of example, the flat surface or concave surface extends in the axial direction from the intersection between the flat surface or concave surface and the floor surface to the second circumferential extension.

As mentioned above, the second circumferential extension is axially located at the axial distance from the floor surface. The axial distance is a quarter of the depth of the piston bowl. In other examples, the flat surface or concave surface may extend in the axial direction from the floor surface to a given intermediate axial distance being greater than the quarter of the depth of the piston bowl but less than the depth of the piston bowl. In other words, the flat surface or concave surface may extend in the axial direction from the floor surface towards to a distance in the axial direction between the quarter of the depth of the piston bowl but less than the depth of the piston bowl.

Each one of the spaced-apart protrusions may extend in the radial direction at least partly over the floor portion.

The first circumferential extension may generally be a maximum circumferential extension of the extension of the flat surface or concave surface, as measured along the circumferential direction. The first circumferential extension is thus a maximum circumferential extension of the flat surface or concave surface. Hence, the first circumferential extension may generally be referred to as the first maximum circumferential extension. One advantage with a protrusion having its maximum circumferential extension at the lowermost portion (near the floor surface of the piston bowl design) is that the tensile stress in the radial direction can be reduced compared to hitherto known designs of piston bowl protrusions. In other words, a wider circumferential extension of the flat surface or the concave surface at the intersection with the floor surface, may generally contribute to reducing the level of tensile stress in the radial direction.

Each one of the protrusions may extend a substantial part in the axial direction from the floor surface to the piston top end surface.

The flat surface or concave surface may generally extend in the circumferential direction between the opposite radially extending side sections.

According to a second aspect of the disclosure, there is provided a piston for an internal combustion engine, ICE, the piston extending in an axial direction and a radial direction, and having an axial top end comprising a piston bowl intended to form part of a combustion chamber. The piston bowl has an axial floor portion with a floor surface, a circumferential rim portion extending in the axial direction between the floor surface and a top end surface of the axial top end. The piston bowl further has an axial depth defined by an axial distance between the floor surface and the top end surface. The piston bowl further comprises a plurality of spaced-apart protrusions circumferentially distributed around the circumferential rim portion, each one of the spaced-apart protrusions extending a substantial part in the radial direction towards a centre axis, and further extending a substantial part in the axial direction from the floor surface towards the top end surface. Each one of the spaced-apart protrusions has opposite radial side section, and further a flat surface or concave surface extending between the opposite radial side sections. The flat surface or concave surface has a first circumferential extension at an intersection between the flat surface or concave surface and the floor surface. Moreover, a ratio between the sum of the first circumferential extensions of all spaced-apart protrusions along the circumferential rim portion and a circumferential extension of the circumferential rim portion is at least 30%, preferably at least 45%, and most preferred at least 60%.

Effects and features of this second aspect of the present disclosure are largely analogous to those described above in connection with the first aspect of the disclosure. Embodiments mentioned in relation to the first aspect of the present disclosure are largely compatible with the second aspect of the disclosure.

According to a third aspect of the disclosure, there is provided an internal combustion engine, ICE, system comprising an internal combustion engine for combustion of fuel and having a combustion chamber at least partially delimited by a cylinder and a reciprocating piston according to any one of the first aspect and the second aspect. The reciprocating piston is moveable within the cylinder between a bottom dead centre BDC and a top dead centre TDC, wherein the piston top end being arranged to form part of the combustion chamber.

Effects and features of this third aspect of the present disclosure are largely analogous to those described above in connection with the first and second aspects of the disclosure. Embodiments mentioned in relation to the third aspect of the present disclosure are largely compatible with the first and second aspects of the disclosure.

Whilst the present disclosure may be used in any type of ICE system that includes the proposed piston, the present disclosure is particularly useful for a diesel internal combustion system. Hence, according to at least one embodiment, the ICE system is a diesel ICE system. However, the proposed piston may also be used in a hydrogen ICE system. Hence, according to at least one embodiment, the ICE system is a hydrogen ICE system.

According to a fourth aspect of the disclosure, there is provided a vehicle comprising a piston according to any one of the first aspect and the second aspect and/or an internal engine combustion system according to the third aspect. Accordingly, the vehicle comprises a piston according to the first aspect of the disclosure. In addition, or alternatively, the vehicle comprises piston according to the second aspect of the disclosure. In addition, or alternatively, the vehicle comprises an internal combustion engine system according to the third aspect of the disclosure.

Effects and features of this fourth aspect of the present disclosure are largely analogous to those described above in connection with the first, second and third aspects of the disclosure. Embodiments mentioned in relation to the fourth aspect of the present disclosure are largely compatible with the first, second and third aspects of the disclosure.

Further advantages and advantageous features of the disclosure are disclosed in the following description and in the dependent claims. It should also be readily appreciated that different features may be combined to create embodiments other than those described in the following, without departing from the scope of the present disclosure.

The terminology used herein is for the purpose of describing particular examples only and is not intended to be limiting of the disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

### BRIEF DESCRIPTION OF THE DRAWINGS

The above, as well as additional objects, features and advantages of the present disclosure, will be better understood through the following illustrative and non-limiting detailed description of exemplary embodiments of the present disclosure, wherein:

FIG. 1 is a side view of a vehicle comprising an internal combustion engine (ICE) system according to an example embodiment of the present disclosure;

FIG. 2 is a side view of a cylinder and a reciprocating piston of an ICE system according to an example embodiment of the present disclosure;

FIGS. 3A to 3E conceptually illustrate one example embodiment of a piston design for the ICE system in FIG. 2, according to the disclosure;

FIGS. 4A to 4C conceptually illustrate another example embodiment of a piston design for the ICE system, according to the disclosure;

FIGS. 5A to 5C conceptually illustrate yet another example embodiment of a piston design for the ICE system, according to the disclosure; and

FIG. 6 conceptually illustrates yet another example embodiment of a piston design for the ICE system, according to the disclosure.

### DETAILED DESCRIPTION OF EXAMPLE EMBODIMENTS

The present disclosure will now be described more fully hereinafter with reference to the accompanying drawings, in which an exemplary embodiment of the disclosure is shown. The disclosure may, however, be embodied in many different forms and should not be construed as limited to the embodiment set forth herein; rather, the embodiment is provided for thoroughness and completeness. Like reference character refer to like elements throughout the description.

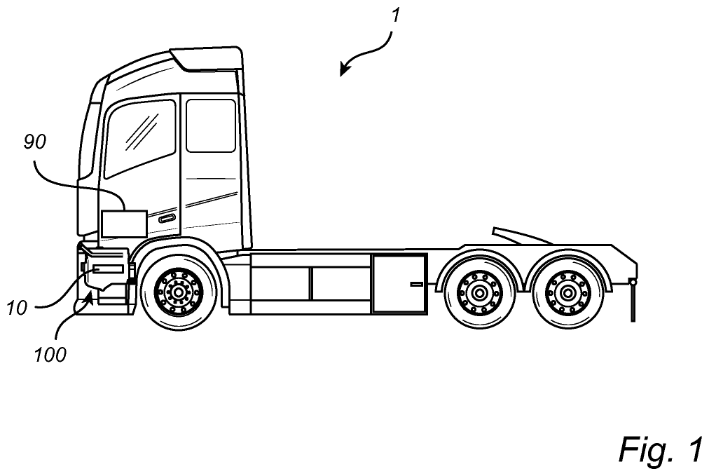

With particular reference to FIG. 1, there is provided a vehicle 1 in the form of a truck. The vehicle 1 comprises an internal combustion engine, ICE, system 100 for powering and driving the vehicle 1. The ICE system 100 in FIG. 1 also comprises an ICE 10. The ICE 10 is intended for combustion of diesel fuel. However, the ICE 10 may also in other examples be provided in the form of a hydrogen internal combustion engine, i.e. an ICE intended for combustion of hydrogen gaseous fuel. In particular, the ICE system 100 is a piston ICE system. The truck is here a vehicle 1 with a single propulsion system where traction power is provided by the ICE system 100. However, the truck may likewise be a hybrid electric vehicle. By way of example, the hybrid electric vehicle comprises a supporting electric propulsion system having at least one high-voltage battery and at least one electric machine, and further the ICE system 100.

As depicted in FIG. 1, the ICE system 100 further comprises a control unit 90, herein also denoted as a controller. The controller 90 is here an integral part of a main electronic control unit for controlling the vehicle and various parts of the vehicle. The controller 90 is arranged in communication with the components of the ICE system 100, in particular the ICE 10. By way of example, the controller 90 is configured to control a controllable fuel injector to inject at least one gaseous fuel jet towards a piston during a fuel injection period. The controller 90 may also be a separate part of the vehicle 1 and communicate with the main electronic control unit for controlling the vehicle and various parts of the vehicle.

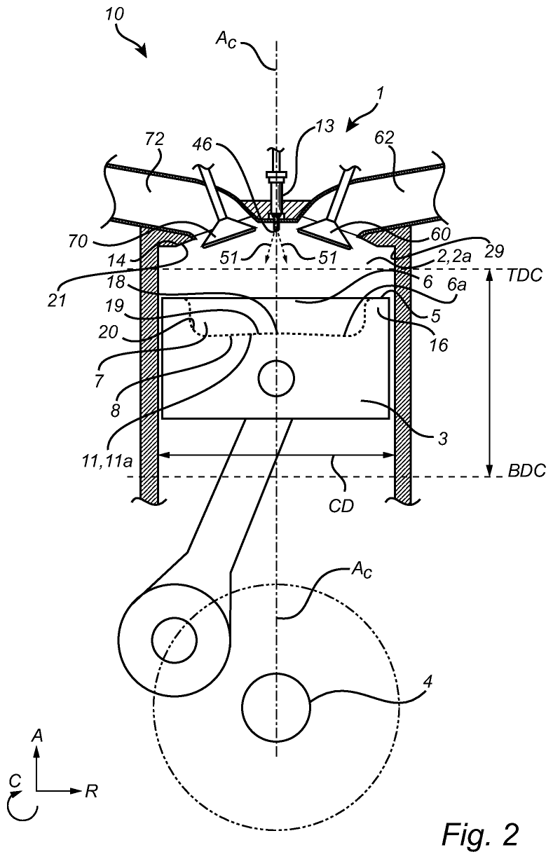

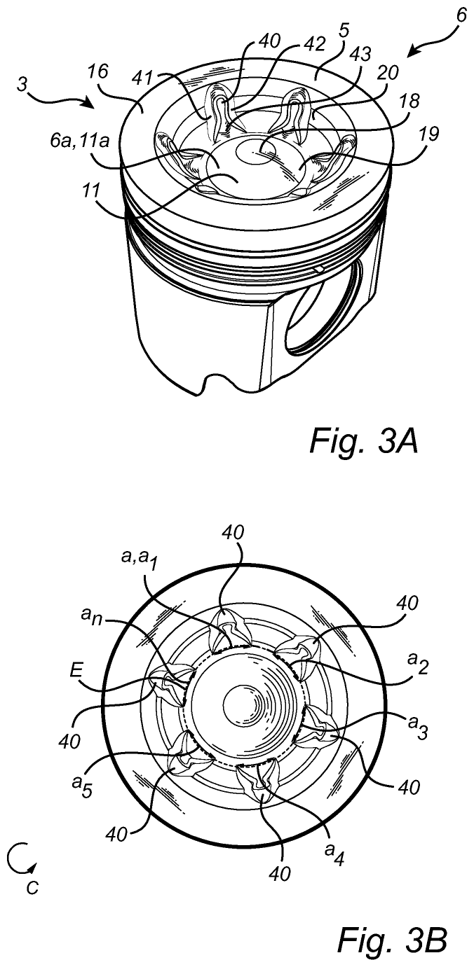

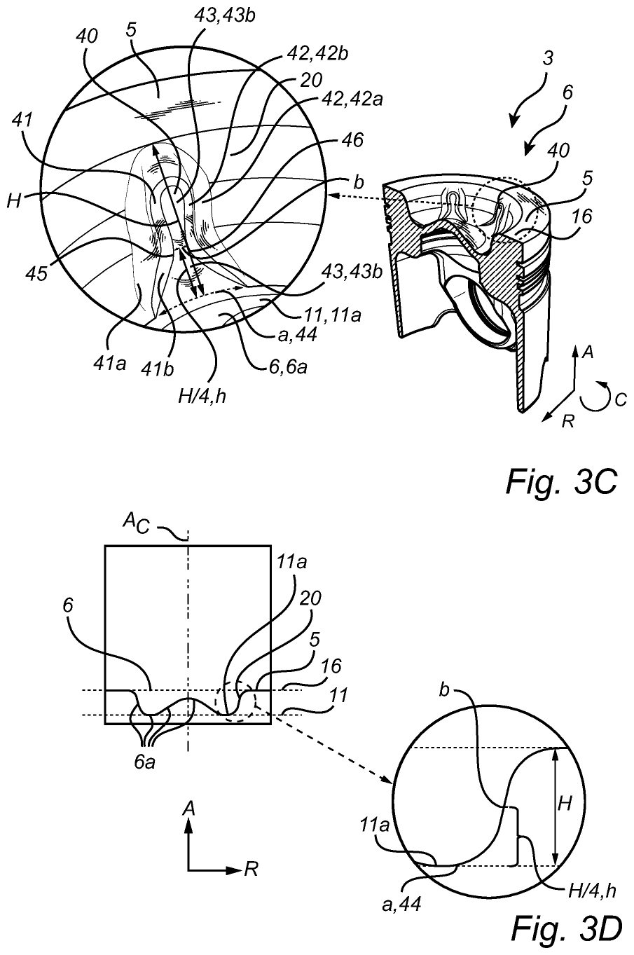

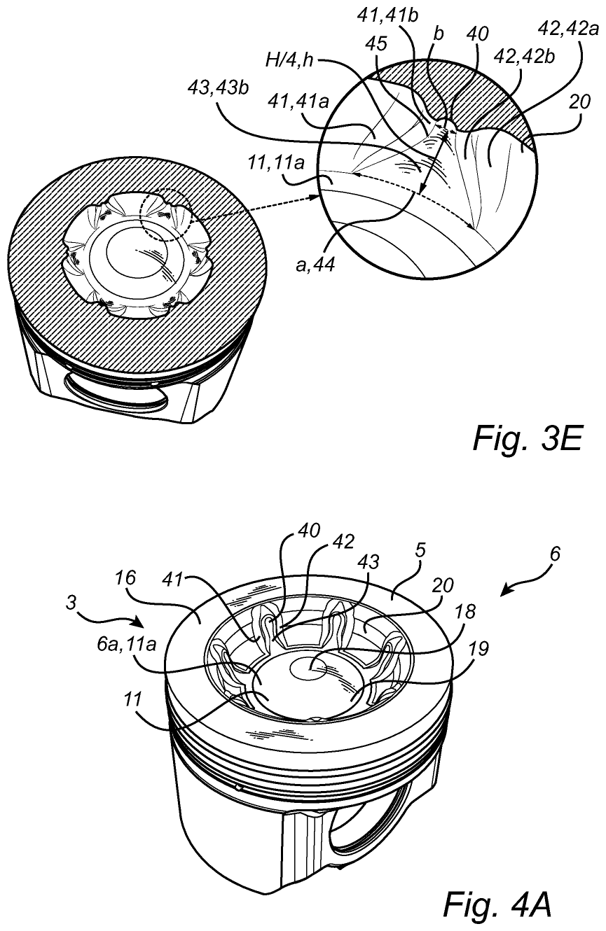

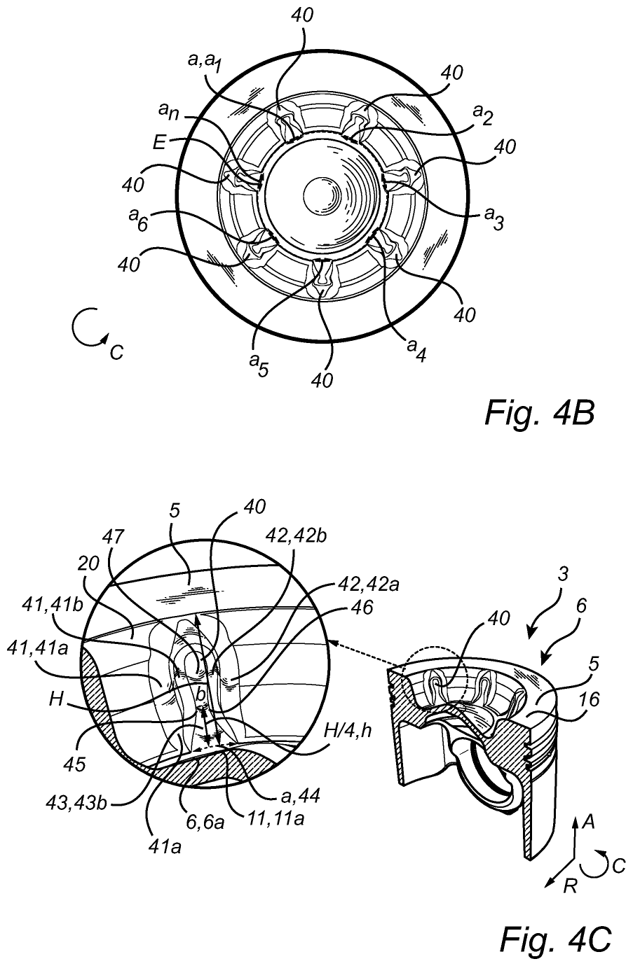

Turning now to FIG. 2, there is depicted one example embodiment of the ICE system 100 for incorporation in the vehicle 1 as described above in relation to FIG. 1. In particular, FIG. 2 is a perspective cross-sectional view of parts of an ICE according to example embodiments of the disclosure. As illustrated in FIG. 2, the ICE 10 comprises at least one cylinder 2. In addition, the ICE 10 has at least one combustion chamber 7 at least partially delimited by the cylinder 2. Moreover, the ICE 10 comprises a piston 3 as disclosed herein, e.g. in FIGS. 2 and 3A to 3E. Other examples of suitable pistons 3 for incorporation in the ICE 10 and ICE system 100 in FIG. 2 are described in relation to FIGS. 4A-4C, 5A to 5C and 6. The piston 3 is arranged and configured to reciprocate inside the cylinder 2. The piston 3 is arranged to reciprocate inside the cylinder 2 such that the ICE 10 is operated to combust fuel (e.g. diesel), whereby the motion of the piston 3 reciprocating in the cylinder 2 is transmitted to a rotational movement of a crank shaft 4, as shown in FIG. 2. The ICE system 100 thus comprises the crankshaft 4.

It is to be noted that whilst FIG. 2 only depicts a single cylinder 2 having the combustion chamber 7 and the reciprocating piston 3 arranged therein, the ICE 10 generally comprises a plurality of cylinders 2 operated to combust fuel (e.g. diesel), whereby the motions of the pistons 3 reciprocating in the cylinders 2 are transmitted to a rotational movement of the crank shaft 4. The crank shaft 4 is further coupled to a transmission (not shown) for providing a torque to driving elements. In case of a heavy-duty vehicle, such as a truck, the driving elements are wheels; however, the ICE system 10 may also be used for other equipment such as construction equipment, marine applications, as power generators, etc.

Generally, each cylinder 2 is provided with a corresponding piston 3 connected to the crankshaft 4 of the ICE 10. As illustrated in FIG. 2, the piston 3 is arranged in the cylinder 2 for reciprocal movement along a centre axis Ac. The piston 3 is mechanically connected to the crankshaft 4 of the ICE 10, so that the piston 3 is movable in the cylinder 2 between an upper dead centre position and a lower dead centre position. The piston 3 thus reciprocates in the cylinder 2 and is connected to the crankshaft 4 so that the piston 3 is set to reverse in the cylinder 2 at the upper and lower dead centre positions. The upper dead centre position is denoted as the top dead centre, TDC, and the lower dead centre position is denoted as the bottom dead centre, BDC, as illustrated by the arrows in FIG. 2.

As also illustrated in e.g. FIG. 2, and further in the other Figures, such as FIGS. 3A to 3E, the piston 3 extends in an axial direction A and in a radial direction R. The piston 3 has a diameter that is less than an inner diameter of the cylinder CD, as shown in FIG. 2. Further, the piston 3 has a circumferential extension along a circumferential direction C. The piston 3 also has a longitudinal centre axis Ac, which hereinafter is generally denoted as the axial centre axis. The axial centre axis Ac of the piston 3 is typically, although strictly not necessary, co-axially arranged with an axial centre axis of a gas injector 13, as illustrated in FIG. 2. However, in some examples, the axial centre axis of the fuel gas injector 13 may be slightly offset the axial centre axis Ac of the piston 3.

As used herein, the terms “radial” or “radially” refer to the relative direction that is substantially perpendicular to an axial centreline of a particular component. Further, the terms “longitudinal”, “longitudinally”, “axially” or “axial” refer to the relative direction that is substantially parallel and/or coaxially aligned to an axial centreline of a particular component. Also, the terms “longitudinal”, “longitudinally”, “axially” or “axial” refer to a direction at least extending between axial ends of a particular component, typically along the arrangement or components thereof in the direction of the longest extension of the arrangement and/or components. The terms “vertical” and “vertically” generally correspond to the axial direction. The axial direction is generally the same direction as the piston moves within the cylinder. Further, the terms “circumference”, “circumferential”, or “circumferentially” refer to a circumference or a circumferential direction relative to an axis, typically a central axis extending in the direction of the longest extension of the device and/or component.

As used herein, the terms “upstream” and “downstream” refer to the relative direction with respect to fluid flow in a fluid pathway. For example, “upstream” refers to the direction from which the fluid flows, and “downstream” refers to the direction to which the fluid flows. Accordingly, in this context, the terms upstream and downstream are generally defined relative to the flow of fuel from a fuel tank to the combustion chamber 7 of the cylinder 2, as illustrated in FIG. 2.

Similarly, terms such as “upper”, “above” and “top” as well as “floor”, “lower”, “bottom”, “below” generally refer to the relative position of the part or component with respect to the axial direction A.

Each one of the cylinders 2 defines at least partly a combustion chamber 7. Each one of the cylinders 2 comprises a cavity 2a defining an inner volume. One end of the cylinder cavity is closed by a cylinder head 14. Further, each one of the cylinders 2 has an inner circumferential side wall 29. In a similar vein, the cylinder head 14 has an inner surface 21. These parts together with a combustion chamber facing portion of the piston 3 generally defines the combustion chamber 7. It should be noted that the cylinder head may be provided in several different shapes, and thus not necessarily in the form of a so called pent-roof type, as illustrated in FIG. 2. By way of example, the cylinder head 14 may have an essentially flat bottom inner surface 21. Other examples of cylinder heads are also possible. In addition, the inner wall of the cylinder may be provided by a so called a cylinder liner, as is commonly known in the art.

As illustrated in FIG. 2, and further in e.g. FIGS. 3A to 3E, the reciprocating piston 3 comprises a piston top end, which herein is denoted as an axial top end 16 of the piston 3. The piston axial top end is here a so called piston crown. The piston axial top end 16 comprises a piston bowl 6. The piston bowl 6 is thus arranged in an upper axial end portion of the piston 3, as illustrated in FIG. 2. The piston bowl 6 is arranged and intended to form part of the combustion chamber 7. As such, the piston bowl 6 is here the combustion chamber facing portion of the piston 3. In FIG. 2, there is depicted one example of providing the piston 3 with a piston bowl 6 at its piston axial top end 16, wherein a surface 6a of the piston bowl 6 is arranged to define the combustion chamber 7 with the cavity 2a of the cylinder 2. As such, as depicted in FIG. 2, the piston bowl surface 6a forms a combustion chamber 7 with the inner surface 21 of the cylinder head 14, and the circumferential side wall 29 of the cylinder 2.

Similar to the piston 3, the piston bowl 6 extends in the axial direction A, in the radial direction R, and having a circumferential extension in the circumferential direction C. In this example, the longitudinal centre axis Ac, i.e. the axial centre axis, of the piston 3 is coaxial with the axial centre axis of the piston bowl 6, as illustrated in FIG. 2.

Each cylinder 2 may further comprise at its vertical top end at least one and typically a multiple number of inlet channels having at least one inlet valve 70 for controlling a flow of the inlet air to the combustion chamber 7, and at least one and typically a multiple number of exhaust channels having a least one exhaust valve 60 for controlling discharge of exhaust gases produced from the fuel combustion process taking place within the cylinder 2.

In particular, in the cylinder head 14, one or more induction ports with corresponding inlet valves 70 are arranged. Accordingly, as depicted in FIG. 2, the ICE system 100 further comprises an intake manifold 72 forming one or more intake guides arranged to guide air to the cylinders 2. In a similar vein, in the cylinder head 14, one or more exhaust ports with corresponding exhaust valves 60 are arranged. Accordingly, as depicted in FIG. 2, the ICE system 100 further comprises an exhaust guide 62 arranged to guide gases from the cylinders 2.

The cylinder configuration may be e.g. straight, V-shaped or any other suitable kind. The ICE system 100 may also include additional engine components and system components.

Moreover, in the cylinder head 14, there is disposed at least one fuel injector 13, through which fuel is injected into the cylinder 2 as a fuel spray 51. The fuel is here diesel fuel. In other examples, the fuel is hydrogen fuel. As such, the fuel injector 13 is arranged vertically into the centre of the roof of the combustion chamber 7.

For diesel ICE systems, the fuel is preferably injected with a pressure in the range 600 to 3000 bar. Generally, for an engine system using EGR, about 1000 to 2500 bar may be preferred, without EGR about 800 to 1400 bar. For hydrogen ICE systems, the hydrogen gas fuel may be injected with a low injection pressure of between 15 to 60 bar into the combustion chamber 7 and towards the piston bowl 6. However, for other gaseous ICE systems, the controllable fuel injector may be controllable to inject gaseous fuel into the combustion chamber with an injection pressure of up to about 500 bar.

Ignited fuel spray may e.g. form a plume in the combustion chamber 7.

The injector 13 may be any suitable type of injector capable of injecting fuel. In general, the fuel injector 13 is arranged in the cylinder 2 and axially above the piston 3. The fuel injector 13 is typically centrally disposed in the cylinder head 14 so that a geometrical centre axis A of the fuel injector 13 coincides with a geometrical centre axis of the cylinder 2, which is also an axis of reciprocation of the piston 3, and here indicated with reference numeral A_{C}. Thus, the geometrical centre axis of the cylinder 2 and the centre axis of the piston 3 may collectively be indicated by the reference A_{C}.

The ICE 10 may advantageously be a four-stroke ICE, comprising a plurality of cylinders 2, each provided with a piston 3, wherein each piston 3 for instance may be connected to a common crankshaft 4. An ICE operable according to a conventional four stroke process performs an intake stroke, a compression stroke, a combustion stroke and an exhaust stroke.

The fuel injector 13 is capable of directly injecting fuel into the combustion chamber 7 and towards the piston 3. The fuel injector 13 comprises at least one, preferably a plurality of injection orifices 46 for permitting the pressurized fuel to flow into the combustion chamber 7. The injected fuel will thereby provide kinetic energy into the combustion chamber 7, so as to induce thorough mixing of the fuel with the air contained therein. In order to enhance the combustion of fuel and air in the combustion chamber 7, the piston 3 further comprises a piston bowl 6 according to any one of the examples illustrated in the FIGS. 3A-3E, 4A-4C, 5A-5C and 6 . The piston 3 and its piston bowl design will be described hereinafter in more detail.

The fuel injector 13 is configured to be controlled by the controller 90 (FIG. 1). Accordingly, the fuel injector is a controllable fuel injector 13. The fuel injector 13 can be controllable by several different type of actuators, including, but not limited, to pneumatic actuation control, electronic actuation control, electro-mechanic actuation control, hydraulic actuation control, and a combination thereof.

The fuel injector 13 is connected and in fluid communication with a fuel tank (not illustrated). The number of fuel gas injectors 13 may be equal to the numbers of cylinders 2 of the ICE 10. The fuel gas injectors 13 are each arranged in fluid communication with the fuel tank.

For hydrogen ICE systems, the ICE 10 may comprise an ignition source, such as a spark-plug (not illustrated).

Turning now again to the design of the piston 3 of the ICE system 100. In FIGS. 3A to 3E there is illustrated one example embodiment of a piston and piston crown that is intended for an ICE 10 and ICE system 100, as described above in relation to FIGS. 1 and 2. In particular, FIG. 3A is a perspective top view of the piston axial top end 16 having a piston bowl 6 according to one example embodiment, FIG. 3B is top view of the piston top end in FIG. 3A, whilst FIG. 3C is a perspective cross-sectional view of the piston axial top end 16 in FIG. 3A, according to one example embodiment. FIG. 3D is a cross-sectional view of the piston 3 and its top end 16 along the axial direction A and the radial direction R. FIG. 3E is a perspective axial cross-sectional view of the piston 3 along a given axial distance (height) of the piston bowl, and along the radial direction R and the circumferential direction C.

In the illustrated embodiments, the piston axial top end 16 forms an integral portion of the piston 3. However, it is also conceivable to provide the piston axial top end 16 as a separate unit, to be attached to one or more piston base portions, so as to form a complete piston 3. The piston axial top end 16 generally amounts to the so called piston crown. The piston axial top end 16 generally has an axial top end surface 5, i.e. an upper surface, facing the combustion chamber 7 of the cylinder 2 when the piston is arranged in the cylinder. The axial top end surface 5 is here the uppermost surface part of the piston 3. For ease of reference, the axial top end surface may be denoted as the top end surface 5.

FIGS. 3A to 3E illustrate the piston axial top end 16 in more detail. As shown in e.g. FIG. 3C, the piston bowl surface 6a faces the combustion chamber 7 when arranged in the ICE 10 as the one exemplified in FIG. 2. The piston bowl surface 6a comprises a circumferential rim portion 20 and a floor portion 11 connected to and surrounded by the circumferential rim portion 20. In other words, the piston bowl 6 comprises the circumferential rim portion 20 and the axial floor portion 11 connected to and surrounded by the circumferential rim portion 20. The axial floor portion 11 comprises a floor surface 11a.

The piston bowl 6 can be provided in several different manners. As illustrated in FIGS. 3A to 3E the floor portion 11 is at least partly defined by the piston bowl surface 6a. The floor portion 11 generally has the floor surface 11a being part of the piston bowl surface 6a. As illustrated in FIG. 2, in conjunction with FIGS. 3A to 3E, the piston bowl 6 is here defined by the circumferential rim portion 20, a central apex 18 and an intermediate section 19. Thus, as may be gleaned from FIGS. 3A to 3E, the floor portion 11 may be generally dome-shaped with the central apex 18 coinciding with the centre axis Ac of the piston 3. The floor portion 11 may form dome side surfaces, forming parts of the intermediate section 19, and extending circumferentially from the dome-shape, and forming a dome angle between them. As such, the floor portion 11 may generally have a dome-shaped geometry, at least partly defined by the central apex 18. The floor portion 11 here extends from the circumferential rim portion 20 to the centre axis Ac in the centre at the central apex 18. The floor portion 11 may align with the circumferential rim portion 20, as illustrated in e.g. FIG. 3A and FIG. 3E.

Generally, although strictly not required, the intermediate section 19 extends between the circumferential rim portion 20 and the central apex 18, thereby together forming the piston bowl surface 6a. By way of example, at least the intermediate section 19 and the central apex 18 here together define the floor surface 11a. In other examples, parts of the rim portion 20, the intermediate section 19 and the central apex 18 together define the floor surface 11a, and thus together define the piston bowl surface 6a.

The circumferential rim portion 20 here also extends in the axial direction A. The circumferential rim portion 20 extends in the axial direction A between the floor surface 11a and the top end surface 5 of the axial top end 16. The circumferential rim portion 20 is here the radially outermost part of the piston bowl 6, whilst the central apex 18 is the radially innermost part of the piston bowl 6. The circumferential rim portion 20, the intermediate section 19 and the central apex 18 collectively form the outwardly opening cavity, as illustrated in e.g. FIG. 3A. In other piston bowl designs where the top end surface may be an integral part of the piston bowl, the top end surface 5 may be the radially outermost part of the piston bowl 6.

The piston bowl 6 has an axial depth H, as depicted in e.g. FIGS. 3C, 3D and 3E. The axial depth H of the piston bowl 6 is defined by an axial distance between the floor surface 11a and the top end surface 5, as illustrated in FIG. 3D, and also indicated in e.g. FIGS. 3C and 3E. Generally, the axial depth H defines the maximum axial distance between the floor surface 11a and the top end surface 5. The axial depth H is thus defined as the distance between the lowermost surface part of the floor portion of the piston bowl 6 and the top end surface 5, as illustrated in FIG. 3D.

In addition, the piston bowl 6 comprises a plurality of spaced-apart protrusions 40, as illustrated in FIGS. 3A to 3E. The protrusions 40 are here disposed on the circumferential rim portion 20. The space-apart protrusions 40 are circumferentially distributed around the centre axis Ac. In particular, the protrusions 40 are circumferentially distributed spaced-apart from each other in the circumferential direction C around the circumferential rim portion 20. Thus, the plurality of spaced-apart protrusions 40 are circumferentially distributed around the circumferential rim portion 20.

In FIGS. 3A to 3E, the circumferential rim portion 20 comprises the plurality of spaced-apart protrusions 40. The spaced-apart protrusions 40 are circumferentially distributed around the circumferential rim portion 20 and about the centre axis Ac. This way, the plurality of spaced-apart protrusions 40 are circumferentially distributed around the circumferential rim portion 20.

It follows from the term “protrusion” that the protrusion section must have a certain axial extension in the axial direction A, a certain radial extension in the radial direction R and a certain circumferential extension along the circumferential direction C.

As such, each one of the spaced-apart protrusions 40 extends a substantial part in the axial direction A from the floor surface 11a towards the top end surface 5. In FIGS. 3A to 3E, each one of the spaced-apart protrusions 40 extends in the axial direction A from the floor surface 11a to the top end surface 5 of the piston top end 16. As such, each one of the spaced-apart protrusions 40 extends in the axial direction A in a continuous manner from the floor surface 11a to the piston top end surface 15. Other extensions may also be conceivable, as further described below.

Moreover, as illustrated in e.g. FIG. 3A, each one of the spaced-apart protrusions 40 extends a substantial part in the radial direction R towards the centre axis AC. Each protrusion 40 extends from adjacent sides of the circumferential rim portion 20 toward the centre axis Ac of the piston 3, forming an apex towards the centre axis Ac. Each one of the protrusion 40 thus faces towards the centre axis Ac of the piston 3. The protrusions 40 are disposed on the circumferential rim portion 20.

Each one of the spaced-apart protrusions comprises opposite radial side sections 41, 42, as illustrated in e.g. FIG. 3A. Each one of the radial side sections 41, 42 extends in the radial direction R and from the circumferential rim portion 20. One of the radial side section is a first radial side section 41, whilst the other one of the radial side sections is a second radial side section 42. Each one of the first radial side section 41 and second radial side section 42 extends in the radial direction. Hence, the radial side section may herein also be denoted as radially extending side sections or radially extending radial side sections. The first radial side section 41 and the second radial side section 42 are arranged opposite each other in the circumferential direction C, as depicted in e.g. FIG. 3A and FIG. 3C.

As illustrated in FIGS. 3A to 3E, the radially extending side sections 41, 42 are curved convex side sections. In other examples the radially extending side sections 41, 42 may be curved concave side sections. In yet other examples the radially extending side sections 41, 42 may be flat side sections.

Moreover, in FIGS. 3A to 3E, each one of the opposite radial side sections 41, 42 comprises multiple regions of different convex curved profiles. In FIG. 3C, there is illustrated one example of a protrusion 40 with a first radially extending side section 41 having first and second convex curved profiles 41a, 41b of different curved convex profiles and a second radially extending side section 42 having first and second convex curved profiles 42a, 42b of different curved convex profiles. In other examples, the first radially extending side section 41 has a uniform curved convex profile, whilst the second radially extending side section 42 has a uniform curved convex profile.

Each one of the spaced-apart protrusions 40 here extends in the radial direction R at least partly over the floor portion 11. Further, each one of the spaced-apart protrusions 40 extends in the radial direction R to align with the floor surface 11a of the floor portion 11.

In the illustrated embodiment in FIGS. 3A to 3E, the piston bowl 6 comprises a total of six protrusions 40, equally distributed around the circumference of the piston bowl 40. However, other numbers of protrusions 40 are conceivable, such as eight protrusions.

The protrusions 40 may be distributed around the central axis AC with 45 degrees intervals. Other intervals are also conceivable.

In FIG. 3A, the spaced-apart protrusions 40 are uniformly circumferentially distributed around the circumferential rib portion 20. In other design variants, although not shown, the spaced-apart protrusions 40 may be non-uniformly circumferentially distributed on the circumferential rib portion 20.

As illustrated in FIGS. 3A to 3E, each one of the spaced-apart protrusions 40 further comprises a surface 43 extending between the opposite radially extending side sections 41, 42. In FIGS. 3A to 3E, the surface 43 extends in the circumferential direction C between the opposite radially extending side sections 41b, 42b. Moreover, in FIGS. 3A to 3E, the surface 43 is a concave surface 43b. FIG. 3E is a cross sectional view of the concave surface 43b, illustrating the concave profile of the concave surface 43b in greater detail. The radius of the concave profile of the concave surface 43b is selected in view of the intended use of the piston 3. By way of example, the radius of the concave profile of the concave surface 43b follows the radius of the curvature of the circumferential rim portion 20. That is, the radius of the concave curvature of the concave surface 43b corresponds to the radius of the concave curvature of the circumferential rim portion 20. In such examples, a radius of curvature of the concave surface is essentially perpendicular to the axial centre of the piston bowl 6. It should, however, be readily appreciated that the radius of the concave profile of the concave surface 43b may have a different concave curvature than the concave curvature of the circumferential rim portion 20. By way of example, FIG. 3C illustrates a design where a radius of the concave curvature of the concave surface 43b is different to the radius of the concave curvature of the circumferential rim portion 20. When defining and designing the concavity of the concave surface 43b, the concavity of the concave surface is generally determined in relation to a Cartesian coordinate system (rather than the cylindrical coordinate system), as is also commonly known in the art. In other words, for the concave surface 43b, the radius of curvature is the radius of a circle that best fits a normal section or combinations thereof. The radius of curvature of the concave surface 43b may either be constant in size along the circumferential direction C or slightly change in size along the circumferential direction C.

In other examples, the surface may be a flat surface. FIG. 6 illustrates one example of the surface 43 in the form of a flat surface 43a in greater detail.

For ease of reference, the following description of the surface 43 will be provided with reference to the concave surface 43b, as illustrated in e.g. FIGS. 3A to 3E. However, the description will likewise be applicable to a surface in the form of the flat surface 43a, as illustrated in FIG. 6.

The concave surface 43b extends a substantial part in the circumferential direction C. As mentioned above, the concave surface 43b here extends between the opposite radially extending radial side sections 41, 42. More specifically, the concave surface 43b extends in the circumferential direction C between the opposite radially extending radial side sections 41, 42. In FIGS. 3a to 3E, the first radial side section 41 of the opposite radial side sections intersects with the concave surface 43b along an intersection edge 45. Analogously, the second radial side section 42 of the opposite radial side sections intersects with the concave surface 43b along another opposite intersection edge 46.

The concave surface 43b is thus arranged to form a bridging surface between the opposite radial side sections 41, 42.

The concave surface 43b is also arranged to face towards the centre axis Ac of the piston 3.

In other words, by providing a flat surface 43a or a concave surface 43b between the opposite radial side sections 41, 42, the surface 43, 43a, 43b between the opposite radial side sections is a non-convex surface. The term “non-convex”, as used herein means that the surface 43 does not protrude towards the centre axis Ac of the piston 3. Rather, the surface 43, 43a, 43b is straight or recesses towards a radially outer circumferential surface of the piston 3, as may be gleaned from e.g. FIG. 3E.

In some examples, as may be gleaned from FIG. 3E, a radial cross sectional profile through the protrusion 40 resembles a truncated triangle or the like, where the truncated side forms the flat surface 43a or the concave surface 43b.

The piston bowl 6 is generally obtained by forging. By way of example, the surface 43, 43a, 43b of the piston bowl 6 is forged.

Also, the concave surface 43b extends a substantial part in the axial direction A. As illustrated in e.g. FIG. 3A, and also in FIG. 3E, the concave surface 43b essentially extends in the axial direction A from an intersection 44 between the concave surface 43b and the floor surface 11a to the top end surface 5 of the piston top end 16. The intersection 44 defines the distinction between the concave surface 43b and the floor surface 11a. As such, the intersection 44 also defines the distinction between the protrusion 40 and the floor surface 11a. The intersection 44 extends in the circumferential direction C. Also, the intersection 44 may generally be an imaginary line illustrating the circumferential extension of the concave surface 43b at its maximum circumferential extension, which in FIG. 3C is illustrated by the reference numeral a.

In FIGS. 3A to 3E, the concave surface 43b has at least an extension between a first circumferential extension, a, at the intersection 44 and a second circumferential extension, b, at an axial distance h from the intersection 44. In this example, the first circumferential extension, a, is larger than the second circumferential extension, b. The first circumferential extension a is larger in the circumferential direction C than the second circumferential extension b.

Generally, the first circumferential extension, a, is the maximum circumferential extension of the concave surface 43b in the circumferential direction C. That is, the first circumferential extension, a, defines the maximum circumferential extension of the concave surface 43b in the circumferential direction C. In the following description, the first circumferential extension thus generally refers to the first maximum circumferential extension, a.

In particular, as illustrated in FIGS. 3A to 3E, the concave surface 43b has the first maximum circumferential extension, a, at the intersection 44 between the concave surface 43b and the floor surface 11. In addition, as illustrated in FIGS. 3A to 3E, the concave surface 43b has the second circumferential extension b at the axial distance h from the floor surface 11a. The axial distance h is a quarter of the piston bowl depth H. The axial distance h and the depth H refer to distances in the axial direction A. In addition, the axial distance h and the depth H refer to distances in the axial direction A as measured in a direction from the floor surface 11a towards the top end surface 5.

As illustrated in e.g. FIG. 3A in conjunction with FIG. 3E, the intersection edges 45, 46 in combination with the first maximum circumferential extension, a, and the second circumferential extension, b, define the extension of the concave surface 43b.

Further, a ratio between the second circumferential extension, b, and the first maximum circumferential extension, a, is 0.4 or less. Hereby, the protrusion 40 is designed so as to improve the durability and the fatigue properties of the protrusion during ordinary operation of the piston 3. The protrusion 40 has an improved design withstanding higher fatigue levels in comparison with other designs of piston bowl protrusions. The ratio between the second circumferential extension, b, and the first maximum circumferential extension is herein also denoted as the relative circumferential width ratio.

In one example, the ratio between the second circumferential extension, b, and the first maximum circumferential extension, a, is 0.4.

In one example, the ratio between the second circumferential extension, b, and the first maximum circumferential extension, a, is 0.

In one example, the ratio between the second circumferential extension, b, and the first maximum circumferential extension, a, is 0.26. By way of example, the second circumferential extension, b, is 2.4 mm and the first maximum circumferential extension, a, is 9.3 mm. In this example, the depth H is 18.6 mm.

In one example, the ratio between the second circumferential extension, b, and the first maximum circumferential extension, a, is 0.25. By way of example, the second circumferential extension, b, is 4.2 mm and the first maximum circumferential extension, a, is 16.8 mm. In this example, the depth H is 19.4 mm.

In one example, the ratio between the second circumferential extension, b, and the first maximum circumferential extension, a, is 0.17. By way of example, the second circumferential extension, b, is 2.9 mm and the first maximum circumferential extension, a, is 17.5 mm. In this example, the depth H is 18.5 mm.

In one example, the ratio between the second circumferential extension, b, and the first maximum circumferential extension, a, is between 0.4 and 0. In one example, the ratio between the second circumferential extension, b, and the first maximum circumferential extension, a, is 0.4 or less, but greater than 0. Hence, in one example, the ratio between the second circumferential extension, b, and the first maximum circumferential extension, a, is between 0.4 and 0.05. In one example, the ratio between the second circumferential extension, b, and the first maximum circumferential extension, a, is between 0.4 and 0.1. In one example, the ratio between the second circumferential extension, b, and the first maximum circumferential extension, a, is between 0.3 and 0.15. In one example, the ratio between the second circumferential extension, b, and the first maximum circumferential extension, a, is between 0.26 and 0.17. In one example, the ratio between the second circumferential extension, b, and the first maximum circumferential extension, a, is between 0.25 and 0.17.

The above relative circumferential width ratio in combination with the configuration of the surface 43 in the form of the flat surface 43a or concave surface 43b provides an improved design of the protrusions at the lower area of the protrusion, and thus at the lower part of the piston bowl 6. More specifically, by having protrusions 40 comprising the flat surface 43a or concave surface 43b extending between opposite radial side sections 41, 42 in combination with the provision that the ratio between the second circumferential extension, b, and the first circumferential extension, a, is 0.4, or less, the piston 3 has a less sensitive design in terms of required durability. Such design can also better withstand critical fatigue conditions that occur during ordinary use of the piston 3 in heavy-duty vehicles.

The above configuration of the protrusions is partly based on the observation that a piston operating in a “hot state”, i.e. the piston 3 is exposed to a high temperature load, there is generated high compression stress at the protrusions. When the magnitude of the compression stress exceeds a critical level, at a certain temperature, the material in the area of the protrusion may be subject to stress relaxation. Stress relaxation may e.g. occur as a result of long-term exposure to high levels of stress that are still below the yield strength of the material. Then, when the vehicle is parked with the ICE turned off, i.e. the ICE is not operating, or at an idling state of the ICE, the piston 3 may cool to a “cold state”, which results in a transformation of the stress from compression stress to tensile stress. When the piston 3 is subsequently exposed to a cylinder pressure load, a fatigue crack may initiate and propagate at a more conventional protrusion due to a cycle of maximum tensile stress from cylinder pressure and maximum tensile stress from stress relaxation.

The above configuration of the flat surface and the concave surface allows for avoiding, or at least reducing, that critical material regions of the protrusions being exposed to high tensile stress.

In addition, the relative circumferential width ratio in combination with the configuration of the surface 43 in the form of the flat surface 43a or concave surface 43b ensure that the part of the protrusion 40 where there is a low impact on combustion performance is designed so as to minimize the compressive stress at the protrusions in the axial lower region for the temperature load occurring during combustion. In addition, the flat surface 43a or concave surface 43b arranged between the radial side sections 41, 42 contributes to separating the location of the maximum compressive stress due to temperature load from the maximum tensile stress location due to the pressure load. A piston bowl 6 with protrusions 40 where maximum stress regions are separated from each other contributes to increasing the durability and fatigue life of the protrusions 40, and thus also the durability of the piston 3.

As illustrated in FIG. 3E, the convex surface 43b itself provides for a bowl-shaped design of a lower part of the protrusion 40.

It should be noted that the concave surface 43b may extend further in the axial direction A than to the second circumferential extension b. As illustrated in FIGS. 3A to 3E, the concave surface 43b extends in the axial direction A from the floor surface 11a and generally the entire way to the top end surface 5. By way of example, the concave surface 43b extends in the axial direction A from the floor surface 11a completely to the top end surface 5. However, in other examples, the concave surface 43b extends in the axial direction A from the floor surface 11a to a given intermediate axial distance between the quarter of the depth of the piston bowl 6 and the depth H of the piston bowl 6. Accordingly, the concave surface 43b generally extends in the axial direction A from the floor surface 11a and towards the top end surface 5. By way of example, the concave surface 43b generally extends in the axial direction A from the floor surface 11a and towards the top end surface 5, and having an extension in the axial direction A which is greater than the quarter of the depth of the piston bowl 6 but less than the depth H of the piston bowl 6.

Accordingly, as illustrated in e.g. FIG. 3D, an extension of the concave surface 43b from the first circumferential extension, a, to the second circumferential extension, b, further comprises a concave axially extending region. The concave axially extending region here also extends from the floor surface 11a and towards the top end surface 5. The protrusion 40 here also comprise an additional upper convex axially extending surface, as illustrated in FIG. 3D. The lower concave axially extending region and the upper convex axially extending surface form the shape of an “S”, as depicted in FIG. 3D.

In other examples, the concave surface 43b merely extends in the axial direction A from the floor surface 11a to the second circumferential extension b. As mentioned above, the second circumferential extension b is axially located at the axial distance h from the floor surface 11a. The axial distance h is a quarter of the depth H of the piston bowl 6.

In an example, as also mentioned above, although not illustrated, where the ratio between the second circumferential extension, b, and the first maximum circumferential extension, a, is zero (0), the concave surface 43b merely extends in the axial direction A from the floor surface 11a to the second circumferential extension b. In this way, there is provided a concave surface 43b resembling a triangle, extending in the axial direction A and in the circumferential direction C.

Hence, the extension of the concave surface 43b is defined by the axially inclined intersection edge 45 and the intersection edge 46 together with the first circumferential extension, a, at the intersection 44 and the second circumferential extension, b, at the axial distance h from the intersection 44. Such extension of the concave surface 43b resembles a trapezoid, i.e. a triangular base shape with a maximum circumferential width at the intersection 44 and a minimum width at the other axial side, i.e. at the second circumferential extension, b. In e.g. FIG. 3C, the concave surface 43b forming a trapezoid surface in the axial direction A and in the circumferential direction C may essentially be designed as a duck-foot. It is to be understood that the term “triangular base shape” also encompasses triangles having rounded corners and even triangles the apex of which is cut, forming an equal-sided trapezoid. Also triangles with non-linear circumferential edges are conceivable.

As illustrated in FIGS. 3A to 3E, the intersection edges 45, 46 inclines from the first maximum circumferential extension, a, to the second circumferential extension b in a non-linear manner (curved manner). However, the intersection edges 45, 46 may likewise incline from the first maximum circumferential extension, a, to the second circumferential extension b in a linear manner. The intersection edges 45, 46 inclines towards a centre region (in the circumferential direction) located on the second circumferential extension b, as illustrated in FIGS. 3A to 3E. The intersection edges 45, 46 in combination with the first circumferential extension, a, and the second circumferential extension, b, define the overall extension of the concave surface 43, 43a, 43b.

In a similar vein as the concave surface 43b, the spaced-apart protrusions 40 may extend in the axial direction A in several different manners. As mentioned above, and as illustrated in FIGS. 3A to 3E, each one of the spaced-apart protrusions 40 extends in the axial direction A between the floor surface 11a of the floor portion 11 and towards the top end surface 5 of the piston top end 16. In particular, each one of the spaced-apart protrusions 40 extends in the axial direction A between the floor surface 11a of the floor portion 11 and to the top end surface 5 of the piston top end 16. It is to be noted that the intersection edges 45, 46 in FIGS. 3A to 3B may generally extend in the axial direction A between the floor surface 11a of the floor portion 11 and towards the top end surface 5.

In another example, each one of the spaced-apart protrusions 40 may merely extend in the axial direction A from the floor surface 11a to the second circumferential extension, b. As mentioned above, the second circumferential extension, b, is axially located at the axial distance h from the floor surface 11a. The axial distance h is a quarter of the depth H of the piston bowl 6. In other examples, each one of the spaced-apart protrusions 40 may extend in the axial direction A from the floor surface 11a to a given intermediate axial distance, which is greater than the quarter of the depth of the piston bowl 6 but less than the depth of the piston bowl 6. In other words, each one of the spaced-apart protrusions 40 may extend in the axial direction A from the floor surface 11a towards the top end surface 5 to a distance in the axial direction A between the quarter of the depth of the piston bowl 6 but less than the depth H of the piston bowl 6. In this example, the concave surface 43b generally extends in a similar vein, i.e. from the floor surface 11a and towards the top end surface 5 in the axial direction A between the quarter of the depth of the piston bowl 6 but less than the depth of the piston bowl H.

Optionally, a ratio between the sum of the first circumferential extensions a₁, a₂, aₙ of all spaced-apart protrusions 40 along the circumferential rim portion 20 and a circumferential extension E of the circumferential rim portion 20 is at least 30%, preferably at least 45%, and most preferred at least 60%. This ratio may also be referred to as the circumferential extension ratio. The circumferential extension ratio is a ratio defined in percentage. The percentage is a dimensionless number whilst the base unit of the extensions refer to length.

In one example, the circumferential extension ratio between the sum of the first circumferential extensions a1, a2, aₙ of all spaced-apart protrusions 40 along the circumferential rim portion 20 and a circumferential extension E of the circumferential rim portion 20 is 0.36. By way of example, the first maximum circumferential extension, a, is 9.3 mm and the circumferential extension E is 26.1 mm. In this example, the second circumferential extension, b, may e.g. be 2.4 mm.

In one example, the circumferential extension ratio between the sum of the first circumferential extensions a1, a2, aₙ of all spaced-apart protrusions 40 along the circumferential rim portion 20 and a circumferential extension E of the circumferential rim portion 20 is 0.65. By way of example, the first maximum circumferential extension, a, is 16.8 mm and the circumferential extension E is 26.0 mm. In this example, the second circumferential extension, b, may e.g. be 4.2 mm.

In one example, the circumferential extension ratio between the sum of the first circumferential extensions a1, a2, aₙ of all spaced-apart protrusions 40 along the circumferential rim portion 20 and a circumferential extension E of the circumferential rim portion 20 is 0.64. By way of example, the first maximum circumferential extension, a, is 17.5 mm and the circumferential extension E is 27.4 mm. In this example, the second circumferential extension, b, may e.g. be 2.9 mm.

In some examples, each one of the spaced-apart protrusions 40 extends in the radial direction R from the circumferential rim portion 20 to at least the intermediate section 19. In addition, the circumferential rim portion 20 extends in the axial direction A between the floor portion 11 and the piston top end 16, typically between the floor surface 11a of the floor portion 11 and the top end surface 5 of the piston top end 16.

In FIGS. 4A to 4C, there is illustrated another design of the piston bowl 6, wherein the concave surface 43b comprises a smaller first maximum circumferential extension, a, compared to the first maximum circumferential extension, a, of the concave surface 43b in FIGS. 3A to 3E, whilst the second circumferential extension, b, of the concave surface 43b in FIGS. 4A to 4C is the same as the second circumferential extension, b, of the concave surface 43b in FIGS. 3A to 3E. The piston design in FIGS. 4A to 4C is another example of a concave surface 43b, where a ratio between the second circumferential extension b and the first maximum circumferential extension a is 0.4 or less.

Moreover, in FIGS. 4A to 4C, the concave surface 43 b extends in the axial direction A from the floor surface 11a to the axial distance h corresponding to the axial location of the second circumferential extension, b. The protrusion 40 here comprises an additional surface region 47. The additional surface region 47 extends in the axial direction from the axial distance h corresponding to the axial location of the second circumferential extension, b, and to the top end surface 5. The additional surface region 47 is here of another profile than the surface 43, e.g. a convex surface. As such, the additional surface region 47 is here of another profile than the concave surface 43a. The additional surface region 47 may be of a similar curved surface profile as the curved profiles of the radial side sections 41, 42. The additional surface region 47 may likewise be of a different surface profile than the curved profiles of the radial side sections 41, 42. As illustrated in FIGS. 4A to 4C, the additional surface region 47 extends in the circumferential direction C and generally extends in-between the radial side sections 41, 42. The additional surface region 47 also mates with the top end surface 5, as illustrated in FIGS. 4A to 4C. The additional surface region 47 here mates with the top end surface 5 in a convex curved manner, as seen in the radial direction R.

Hence, as is readily appreciated from the above, the concave surface 43b at least extends in the axial direction A from the first maximum circumferential extension, a, to the axial distance h (H/4), corresponding to the axial location of the second circumferential extension, b. Depending on the design of the protrusion 40, the concave surface 43b then either terminates at the axial distance h (H/4), i.e. at the second circumferential extension, b, or extends to a given intermediate axial distance between the quarter of the depth H of the piston bowl 6 and the depth H of the piston bowl 6. If the concave surface 43b terminates at the axial distance h (H/4), i.e. at the second circumferential extension, b, the remaining parts of the protrusion 40 axially above the concave surface 43b are generally formed by the additional surface region 47 together with the radial side sections 41, 42. Analogously, if the concave surface 43b terminates at a given intermediate axial distance between the quarter of the depth H of the piston bowl 6 and the depth H of the piston bowl 6, the remaining parts of the protrusion 40 axially above the concave surface 43b are generally formed by the additional surface region 47 together with the radial side sections 41, 42. However, in other examples, as illustrated in FIGS. 3A to 3E, there is no additional surface region 47. That is, the surface 43 in the form of the concave surface 43b essentially extends to the top end surface 5. Due to the overall design of the protrusion 40, there may generally be a smooth curvilinear transition surface between the concave surface 43b and the top end surface 5, as may be gleaned from e.g. FIG. 3C.

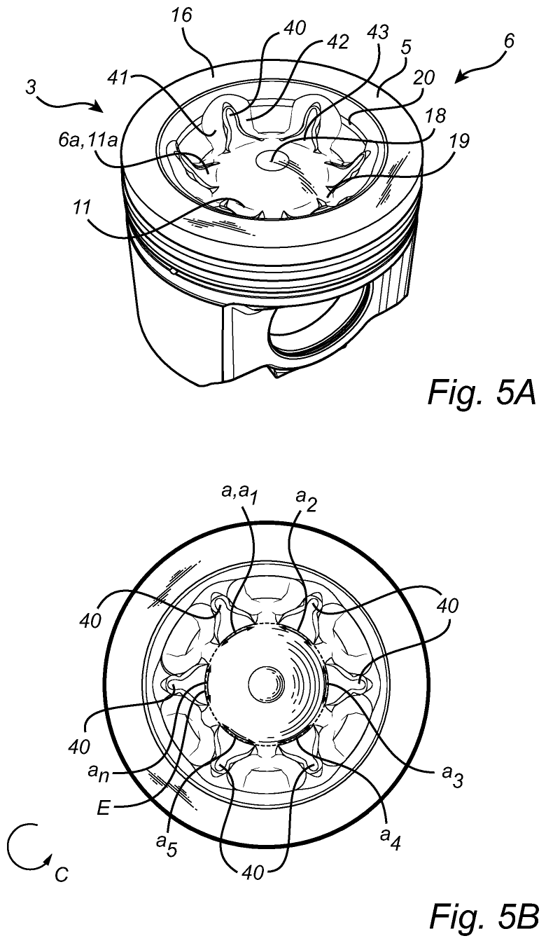

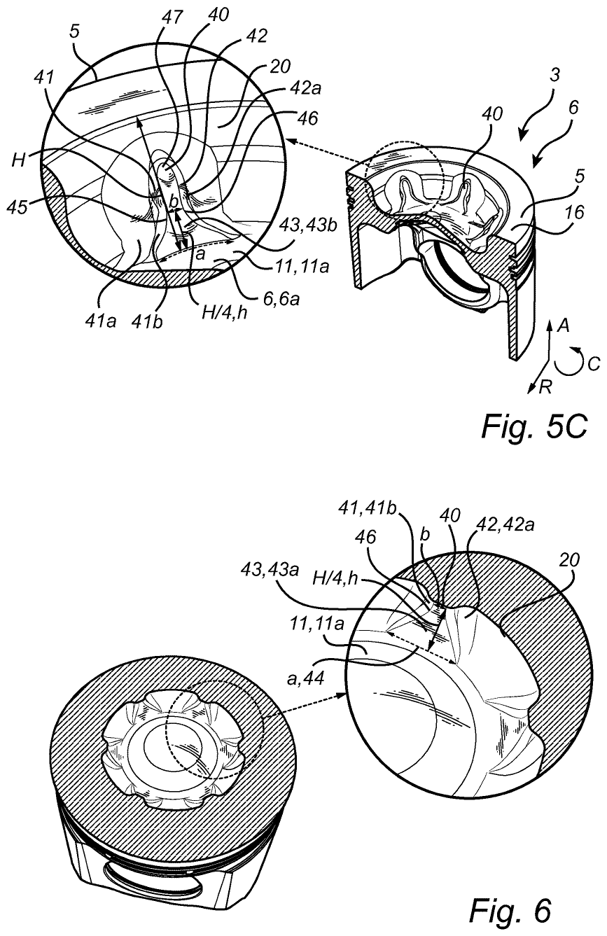

In FIGS. 5A to 5C, there is illustrated another design of the piston bowl 6, where each one of the spaced-apart protrusions 40 extends to an axial distance that is less than the top end surface 5, as measured from the floor surface 11a. In addition, in this example, the concave surface 43b has a first maximum circumferential extension, a, that is the same as the first maximum circumferential extension, a, of the concave surface 43b in FIGS. 4A to 4E, whilst the second circumferential extension, b, of the concave surface 43b in FIGS. 5A to 5C is the same as the second circumferential extension, b, of the concave surface 43b in FIGS. 3A to 3E and FIGS. 4A to 4C. The piston design in FIGS. 5A to 5C is another example of a concave surface 43b, where a ratio between the second circumferential extension b and the first maximum circumferential extension a is 0.4 or less. Accordingly, an increased fatigue of the protrusion can be provided by a number of different concave surfaces 43b.

Similar to the design as illustrated in FIGS. 4a to 4C, the concave surface 43b in FIGS. 5A to 5C merely extends in the axial direction A from the floor surface 11a to the axial distance h corresponding to the axial location of the second circumferential extension, b. The protrusion 40 thus here also comprises the additional surface region 47. The additional surface region 47 extends in the axial direction from the axial distance h corresponding to the axial location of the second circumferential extension, b, and to the top end surface 5. The additional surface region 47 is here also a convex surface profile. However, in other examples, the concave surface 43b in FIGS. 5A to 5C may likewise extend to the top end surface 5 in a similar vein as in FIGS. 3A to 3C.

It should be noted that the other conditions, examples and features as described in relation to FIGS. 1, 2 and FIGS. 3A to 3E may be incorporated and combined with the conditions, examples and features of FIGS. 4A to 4C and FIGS. 5A to 5C unless defined in another way.

FIG. 6 illustrates one example of a protrusion 40 with a flat surface 43a instead of the concave surface. Also in this example, the ratio between the second circumferential extension b and the first maximum circumferential extension a is 0.4 or less. Accordingly, an increased fatigue of the protrusion can be provided either by a concave surface 43b or a flat surface 43a, provided that the ratio between the second circumferential extension b and the first maximum circumferential extension a is 0.4 or less. In FIG. 6, the axial extension of the flat surface 43a from the first circumferential extension, a, to the second circumferential extension, b, is also defined by a concave surface. However, in other examples, the axial extension of the flat surface 43a from the first circumferential extension, a, to the second circumferential extension, b, is also defined by a flat surface.

It should be noted that the other conditions, examples and features as described in relation to FIGS. 1, 2, FIGS. 3A to 3E, FIGS. 4A to 4C and FIGS. 5A to 5C may be incorporated and combined with the piston bowl 6 of FIG. 6 unless defined in another way.

To sum up, there is provided a piston 3 extending in the axial direction A and the radial direction R. The piston 3 comprises the axial top end 16 having the piston bowl 6 intended to form part of the combustion chamber 7. The piston bowl 6 comprises the axial floor portion 11 having the floor surface 11a, the circumferential rim portion 20 extending in the axial direction A between the floor surface 11a and the top end surface 5 of the axial top end 16. The piston bowl 6 defines an axial depth H defined by an axial distance between the floor surface 11a and the top end surface 5. Moreover, the piston bowl 6 comprises a plurality of spaced-apart protrusions 40 circumferentially distributed around the circumferential rim portion 20. Each one of the spaced-apart protrusions 40 extends a substantial part in the radial direction R towards a centre axis Ac, and further extending a substantial part in the axial direction A from the floor surface 11a towards the top end surface 5. Each one of the spaced-apart protrusions 40 having opposite radial side sections 41, 42, and further comprising the flat surface 43, 43a or the concave surface 43, 43b extending between the opposite radial side sections 41, 42. The flat surface 43a or concave surface 43b comprises the first circumferential extension, a, at the intersection 44 between the flat surface or concave surface and the floor surface 11a, and further comprises the second circumferential extension, b, at the axial distance, h, from the floor surface 11a. The axial distance, h, is a quarter of the piston bowl depth H. In addition, the second circumferential extension, b, and the first circumferential extension, a, defines a ratio that is 0.4 or less.

The advantages associated with an improved fatigue can also be provided merely by the circumferential extension ratio, i.e. wherein the ratio between the sum of the first circumferential extensions a1, a2, aₙ of all spaced-apart protrusions 40 along the circumferential rim portion 20 and a circumferential extension E of the circumferential rim portion 20 is at least 30%, preferably at least 45%, and most preferred at least 60%.

Accordingly, there is also provided a piston 3 extending in the axial direction A and the radial direction R. The piston 3 comprises the axial top end 16 having the piston bowl 6 intended to form part of the combustion chamber 7. The piston bowl 6 comprises the axial floor portion 11 having the floor surface 11a, the circumferential rim portion 20 extending in the axial direction A between the floor surface 11a and the top end surface 5 of the axial top end 16. The piston bowl 6 defines an axial depth H defined by an axial distance between the floor surface 11a and the top end surface 5. Moreover, the piston bowl 6 comprises a plurality of spaced-apart protrusions 40 circumferentially distributed around the circumferential rim portion 20. Each one of the spaced-apart protrusions 40 extends a substantial part in the radial direction R towards a centre axis Ac, and further extending a substantial part in the axial direction A from the floor surface 11a towards the top end surface 5. Each one of the spaced-apart protrusions 40 having opposite radial side sections 41, 42, and further comprising the flat surface 43, 43a or the concave surface 43, 43b extending between the opposite radial side sections 41, 42. The flat surface 43a or concave surface 43b comprises the first circumferential extension, a, at the intersection 44 between the flat surface or concave surface and the floor surface 11a, Moreover, a ratio between the sum of the first circumferential extensions a1 to an of all spaced-apart protrusions 40 along the circumferential rim portion 20 and the circumferential extension E of the circumferential rim portion 20 is at least 30%, preferably at least 45%, and most preferred at least 60%.

The present disclosure also relates to the ICE system 100 comprising a diesel internal combustion engine, as described herein. The ICE system 100 comprises the internal combustion engine 10 for combustion of fuel and having the combustion chamber 7 at least partially delimited by the cylinder 2 and the reciprocating piston 3 according to any one of the above examples in FIGS. 3A to 3E, 4A to 4C, 5A to 5C and 6. The reciprocating piston is moveable within the cylinder between the bottom dead centre BDC and the top dead centre TDC, wherein the piston top end being arranged to form part of the combustion chamber.

The present disclosure also relates to the vehicle 1 comprising the ICE system 100 and the piston 3 according to according to any one of the above examples in FIGS. 3A to 3E, 4A to 4C, 5A to 5C and 6.

Even though the disclosure has been described with reference to specific exemplifying embodiments thereof, many different alterations, modifications and the like will become apparent for those skilled in the art. Accordingly, it is to be understood that the present disclosure is not limited to the embodiments described above and illustrated in the drawings; rather, the skilled person will recognize that many changes and modifications may be made within the scope of the appended claims.

1. A piston for an internal combustion engine, ICE, said piston extending in an axial direction and a radial direction, and having an axial top end comprising a piston bowl intended to form part of a combustion chamber,
said piston bowl having an axial floor portion with a floor surface and a circumferential rim portion extending in the axial direction between the floor surface and a top end surface of the axial top end,
said piston bowl further having an axial depth defined by an axial distance between said floor surface and said top end surface,
said piston bowl further comprising a plurality of spaced-apart protrusions circumferentially distributed around said circumferential rim portion,
each one of the spaced-apart protrusions extending a substantial part in the radial direction towards a centre axis, and further extending a substantial part in the axial direction from the floor surface towards said top end surface,
each one of the spaced-apart protrusions having opposite radial side sections, and further a flat surface or concave surface extending between said opposite radial side sections, said flat surface or concave surface having a first circumferential extension at an intersection between said flat surface or concave surface and said floor surface, and further a second circumferential extension at an axial distance from said floor surface, said axial distance being a quarter of said axial depth of the piston bowl, and
wherein a ratio between the second circumferential extension and the first circumferential extension is 0.4 or less.

2. Piston according to claim 1, wherein a ratio between the sum of the first circumferential extensions of all spaced-apart protrusions along the circumferential rim portion and a circumferential extension of the circumferential rim portion is at least 30%.

3. Piston according to claim 1, wherein a first radial side section of the opposite radial side sections intersects with the flat surface or concave surface along an intersection edge and a second radial side section of the opposite radial side sections intersects with the flat surface or concave surface along another opposite intersection edge.

4. Piston according to claim 3, wherein said intersection edges in combination with said first circumferential extension said second circumferential extension define the extension of the flat surface or the concave surface.

5. Piston according to claim 3, wherein each one of said intersection edges inclines from said first circumferential extension to said second circumferential extension, respectively, in a linear manner or in a non-linear manner.

6. Piston according to claim 3, wherein said intersection edges in combination with said first circumferential extension and said second circumferential extension define a surface resembling a trapezoid or a triangular shape.

7. Piston according to claim 1, and wherein an extension of the flat surface or the concave surface from said first circumferential extension to said second circumferential extension further comprises a concave axially extending region.

8. Piston according to claim 1, wherein an extension of the flat surface from said first circumferential extension to said second circumferential extension is defined by a flat surface profile.

9. Piston according to claim 1, wherein each one of the opposite radial side sections comprises multiple regions of different convex curved profiles.

10. Piston according claim 1, wherein the spaced-apart protrusions are uniformly circumferentially distributed along the circumferential rim portion.

11. Piston according to claim 1, wherein the spaced-apart protrusions are non-uniformly circumferentially distributed along the circumferential rim portion.

12. Piston according to claim 1, wherein each one of the spaced-apart protrusions extends in the axial direction from the floor surface to the top end surface of said piston top end.

13. Piston according to claim 1, wherein said flat surface or concave surface extends in the axial direction from the intersection between said flat surface or concave surface and said floor surface and towards the top end surface of said piston top end.

14. Piston according to claim 13, wherein said flat surface or concave surface extends in the axial direction from the intersection between said flat surface or concave surface and said floor surface to the top end surface of said piston top end.

15. Piston according to claim 13, wherein said flat surface or concave surface extends in the axial direction from the intersection between said flat surface or concave surface and said floor surface to the second circumferential extension.

16. Piston according to claim 1, wherein each one of the spaced-apart protrusions extends in the radial direction at least partly over the floor portion.

17. Piston according to claim 1, wherein the first circumferential extension is a maximum circumferential extension of the flat surface or concave surface.

18. A piston for an internal combustion engine, ICE, said piston extending in an axial direction and a radial direction, and having an axial top end comprising a piston bowl intended to form part of a combustion chamber,
said piston bowl having an axial floor portion with a floor surface and a circumferential rim portion extending in the axial direction between the floor surface and a top end surface of the axial top end,
said piston bowl further having an axial depth defined by an axial distance between said floor surface and said top end surface,
said piston bowl further comprising a plurality of spaced-apart protrusions circumferentially distributed around said circumferential rim portion,
each one of the spaced-apart protrusions extending a substantial part in the radial direction towards a centre axis, and further extending a substantial part in the axial direction from the floor surface towards the top end surface,
each one of the spaced-apart protrusions having opposite radial side sections, and further a flat surface or concave surface extending between said opposite radial side sections, said flat surface or concave surface having a first circumferential extension at an intersection between said flat surface or concave surface and said floor surface, wherein a ratio between the sum of the first circumferential extensions of all spaced-apart protrusions along the circumferential rim portion and a circumferential extension of the circumferential rim portion is at least 30%.

19. An internal combustion engine, ICE, system comprising an internal combustion engine for combustion of fuel and having a combustion chamber at least partially delimited by a cylinder and a reciprocating piston according to claim 1, said reciprocating piston being moveable within said cylinder between a bottom dead centre and a top dead centre, wherein said piston top end being arranged to form part of the combustion chamber.

20. A vehicle comprising a piston according to claim 1 and an internal engine combustion system.
